(19) United States
(12) Patent Application Publication
(10) Pub. No.: US 2010/0052859 A1
(43) Pub. Date: Mar. 4, 2010

(54) Transponder Comprising an Electronic Memory Chip and Magnetic Circular Antenna

(75) Inventor: Harald Lossau, Munchen (DE)

Correspondence Address: THE WEBB LAW FIRM, P.C., 700 KOPPERS BUILDING, 436 SEVENTH AVENUE, PITTSBURGH, PA, 15219, US

(73) Assignee: DYNAMIC SYSTEMS GMBH, Weßling (DE)

(21) Appl. No.: 12/305,435

(22) PCT Filed: Jun. 21, 2007
(86) PCT No.: PCT/EP2007/005470

§ 371 Date: Oct. 5, 2009

(30) Foreign Application Priority Data
Jun. 21, 2006 (DE) 10 2006 028 827.0

(51) Int. Cl. H04Q 5/22; H01Q 1/00

(52) U.S. Cl. 340/10.1; 343/787; 343/729

(57) ABSTRACT

In a transponder having an electronic memory chip and a magnetic ring antenna is provided that the ring antenna comprises an electrically conductive coil having at least one turn, and a capacitor, wherein the capacitor exhibits, as a dielectric, a thin insulator foil that simultaneously serves as a substrate foil for the coil and/or the chip.

### FIELD OF THE INVENTION

The present invention relates to a transponder having an electronic memory chip and a magnetic ring antenna. The present invention further relates to a semifinished transponder product and a manufacturing method for such a transponder.

### BACKGROUND OF THE INVENTION

Transponder technology has been used successfully for years in many applications: Typical examples are the contactless company ID that enables entrance to the workplace, and the immobilizer system based on a transponder built into the vehicle key. Here, the transponder, or RFID, technology proves to be more robust than conventional marking systems, especially labels having barcodes: Despite a growing number of built-in redundancies, the chances of detecting dirty, covered or damaged barcodes are poor. RFID technology, on the other hand, which is not dependent on an optical line of sight, offers a constantly high reading quality also with heavily soiled data carriers. Further advantages of RFID technology are the principally high memory capacities (currently up to 64 kBytes) and the possibility of reprogramming and encrypted data transmission.

A transponder commonly consists of a coupling element (coil or microwave antenna) and an electronic microchip. Passive transponders include no independent voltage supply (battery) and, outside the response range of a reading device, are completely passive. Only inside the response range of a reading device is the transponder activated. The energy needed to operate the passive transponder is transmitted to the transponder contactlessly by the coupling unit, as are timing and data.

A distinction is typically made between inductive or magnetically coupled transponder systems that are used in the frequency range from low frequency (<150 kHz) to high frequency (HF, 13.56 MHz), and electromagnetically coupled systems that are used in the ultra high frequency and microwave range (UHF beginning at 866 MHz).

Inductive systems work in the near field—with magnetic ring antennas whose circumference is often less than one tenth of the wavelength λ. They are generally marked by compact designs and a clearly defined read range.

In contrast, electromagnetically coupled systems are marked by ranges larger than the wavelength λ. Here, antennas with an electric near field, especially dipole antennas, are used that are relatively large, with a length on the order of λ/2.

For magnetic ring antennas, the following designs are known (see Rothammel's “Antennenbuch,” DARC Verlag Baunatal, 12th edition, 2001, chapter 16):
1. Magnetic antennas with bottom tuning and capacitive decoupling,
2. Magnetic antennas with top tuning and galvanic decoupling and
3. Magnetic antennas with inductive decoupling.

Transponders can be manufactured economically in large quantities in the form of transponder labels, or so-called smart labels. These include a foil as a substrate on which a thin—etched or printed—antenna is applied. Here, the chip is either applied directly with high precision standards, or indirectly as a chip module or strap, and is contacted electrically conductively. To create the conductive connection, methods such as conductive adhesion, bonding (welding) or crimping are used that each incur additional costs.

The known transponder systems encounter technical limits in marking small objects: Small designs are possible in inductively coupled systems, but the inductance and the read range decrease with shrinking cross-sectional areas of the ring antenna. Due to the small inductance, a large capacity is required for the common transponder frequencies of inductive systems, which is typically reflected in higher costs. As large an antenna cross-sectional area as possible is thus to be aimed for also in marking small objects.

Due to the length of the dipole antenna, which is determined by the frequency, electromagnetic antennas cannot be folded to an arbitrarily small size. Here, the UHF or microwave range would be advantageous due to the higher frequency in relation to the read range.

### DESCRIPTION OF THE INVENTION

This is where the present invention begins. The object of the present invention, as characterized in the claims, is to avoid the disadvantages of the background art and especially to specify a generic transponder that exhibits a good read range also in small designs and, furthermore, can be produced economically.

According to the present invention, this object is solved by the transponder having the features of the independent claims. Further advantageous details, aspects and embodiments of the present invention are evident from the dependent claims, the description, the drawings and the examples.

The following abbreviations and terms will be used in the context of the present invention:

The abbreviation RFID (radio frequency identification) is used here generally for identification systems with contactless electromagnetic energy and data transmission—independently of the carrier frequency used.

A transponder readout device is understood to be a system that supplies a transponder with energy through electromagnetic fields, reads data from its chip and, optionally, can also write data to the chip.

According to a first aspect of the present invention, in a transponder of the kind cited above is provided that the ring antenna comprises an electrically conductive coil having at least one turn, and a capacitor, and that the transponder is designed for an operating frequency of 860 MHz or more for UHF or the microwave range.

Here, the ring antenna preferably comprises a coil having only one turn. The inductance of the coil is advantageously less than 1 pH, preferably less than 0.2 pH, and the circumference of the coil is expediently less than 20 cm, preferably less than 4 cm. The capacity of the capacitor is advantageously selected from the range 0.1 pF to 20 pF, preferably from the range 0.5 pF to 5 pF.

According to a second aspect of the present invention, in a transponder of the kind cited above is provided that the ring antenna comprises an electrically conductive coil having at least one turn, and a capacitor, wherein the capacitor exhibits, as a dielectric, a thin insulator foil that simultaneously serves as a substrate foil for the coil and/or the chip.

In both aspects of the present invention, especially the following advantages are realized, as stated in greater detail below:
compact design;
simple, economical manufacture;
flexible possibilities for use;
simple possibility of tuning after manufacturing a semifinished transponder product;
simple installation on various objects.

In the transponder of the second aspect of the present invention, the insulator foil is preferably a plastic foil, especially a polyester (PET) foil, a polyimide foil or a polypropylene (PP) foil.

In an advantageous embodiment, the entire transponder is assembled on the insulator foil.

While, in principle, the coil and the memory chip can be arranged on the same side of the insulator foil, it is preferred—in a variant of the present invention—primarily due to the lower requirements for the positioning accuracy, that the coil and the memory chip be assembled on opposing surfaces of the insulator foil.

In a preferred embodiment of the second aspect of the present invention, a second insulator foil is provided that is joined with, especially affixed or welded to, the first insulator foil in such a way that the coil is wrapped between the two insulator foils.

According to a particularly advantageous development of the present invention, the transponder comprises, in addition to the ring antenna, a secondary antenna that is electrically coupled to the ring antenna via an insulator foil. Here, the term “electric coupling” is to be understood as a generic term that comprises both a capacitive and an inductive coupling, as well as a combination of both coupling types.

In a preferred embodiment, the secondary antenna is electrically coupled to the ring antenna via the substrate foil of the ring antenna. Alternatively or additionally, the secondary antenna can be present on a secondary-antenna substrate foil and electrically coupled to the ring antenna via this secondary-antenna substrate foil. Of course the secondary antenna can be present on a secondary-antenna substrate foil also when the electric coupling occurs substantially via the substrate foil of the ring antenna.

As the substrate foil for the secondary antenna, especially a plastic foil may be used, especially a polyester (PET) foil, a polyimide foil or a polypropylene (PP) foil.

The secondary antenna is preferably formed in the manner of a dipole, patch or slot antenna. The secondary antenna can especially be formed by a gap in an otherwise contiguous metal layer. This can be achieved, for example, in that the secondary antenna is formed by etching out a gap from a contiguous metal foil, especially a copper or aluminum foil, or by patterned printing of a conductive paste, especially a silver paste.

In an advantageous embodiment of this variant of the present invention, the transponder is intended for marking an object, the secondary antenna forming a part of the object to be marked. For example, the object to be marked can exhibit a metallic component that is developed in such a way that it can serve as a secondary antenna of a transponder of the kind described. Then the transponder having a transponder chip and a magnetic ring antenna on the thin insulator foil as a substrate is applied to the metallic component of the object, which serves as a secondary antenna, in such a way that the magnetic ring antenna of the transponder and the secondary antenna electrically (capacitively and/or inductively) couple with each other.

The variant of the present invention having an additional secondary antenna permits, through the combination of two different components, a particularly efficient and flexible manufacture: For one thing, the transponder includes a more complex, but small and standardized component, namely the transponder chip on a magnetic ring antenna having a typical diameter of only about 1 cm, for which higher standards are set for the production precision. The reception characteristic of this transponder is improved through the combination of the ring antenna, which is particularly well suited in the magnetic near field, with a secondary antenna that is generally more easily manufacturable, substantially larger, and particularly suited for the electromagnetic far field.

A typical simple, larger and application-specifically adjustable secondary antenna is developed as a dipole, patch or slot antenna and exhibits a dimension on the order of half the wavelength, typically of 10-17 cm. Through a secondary antenna, a more flexible adjustment of the transponder is possible, for example to different materials and/or ambient conditions merely by adjusting the secondary antenna.

In particular, in such embodiments, in marking an at least partially metallic object, the object itself can be used as a secondary antenna of the transponder.

The transponder is preferably designed for an operating frequency above 10 MHz, especially for an operating frequency around 13.56 MHz, 27.1 MHz, 40.68 MHz, 433.92 MHz, 860-960 MHz, 2.45 GHz, 5.8 GHz or 24.1 GHz, and particularly preferably for an operating frequency above 860 MHz, so in the UHF and microwave range, since compact designs can be realized here with the ring antenna according to the present invention.

The insulator foil is advantageously thinner than 50 μm, its thickness is preferably in the range between 10 μm and 40 μm.

In both aspects of the present invention, the coil area A of the conductive coil is expediently less than 40 cm², and is preferably in the range between 0.06 cm² and 4 cm², particularly preferably in the range between 0.18 cm² and 1 cm².

The transponder according to both aspects of the present invention can advantageously be provided with an adhesive layer for the use of the transponder as a self-adhesive transponder label (so-called smart label).

In both aspects, the coil is expediently formed by a circuit path on a substrate foil. In the second aspect of the present invention, the insulator foil advantageously assumes the role of the substrate foil. Here, it is appropriate to form the circuit path by etching out from a contiguous metal foil—especially a copper or aluminum foil—or by printing a conductive paste—especially silver paste.

The number of turns of the coil is preferably less than 20, preferably less than 10, and is especially 1, 2 or 3. Here, the number of turns 1 brings the additional advantage that no bridge is required to join the coil ends.

The transponder of the second aspect of the present invention is advantageously functional in a planar insulator foil, with the antenna coil being arranged parallel to the insulator foil. Alternatively, the insulator foil can not lie parallel to the area spanned by the antenna, but rather protrude out from it. This can be realized, for example, in that the insulator foil is rolled up to form a closed tube along whose circumference the coil runs.

The circuit paths are expediently formed such that the resonance frequency of the antenna does not shift due to positioning imprecisions when rolling up. They are preferably formed such that, in the region of the sub-sections of the two circuit paths lying on top of one another, the one circuit path has a significantly larger dimension than the other.

In a further advantageous embodiment, the circuit paths are formed such that, when rolling up, through specific positioning of the sub-regions lying on top of one another, the resonance frequency of the transponder can be tuned, preferably formed such that the size of the overlapping portion can be selected through the positioning.

The electronic memory can be formed as read-only memory or as rewritable memory.

The present invention further includes a semifinished transponder product having a flexible, electrically insulating substrate having two circuit paths that are each joined on one side with a transponder component, and in which, when rolling up the substrate with a certain circumference, the two circuit paths lie on top of one another in sub-sections in such a way that, with the substrate lying therebetween, they form a ring antenna, and together with the transponder component, a transponder tuned to the desired resonance frequency.

The semifinished transponder product is preferably self-adhesive, such that a transponder can be formed by affixation to an object having a certain circumference.

The substrate of the semifinished transponder product advantageously consists of a plastic foil, especially a polyester foil, a polyimide foil or a polypropylene foil. The circuit paths of the semifinished transponder product expediently consist of metal foil or a conductive paste applied by screen printing.

The transponder component of the semifinished transponder product preferably includes a circuit for frequency stabilization to compensate for differences in the antenna cross section when the substrate is applied to different objects.

The circuit paths are advantageously formed such that the resonance frequency of the antenna does not shift due to positioning imprecisions when rolling up, preferably are formed such that, in the region of the sub-sections of the two circuit paths lying on top of one another, the one circuit path has a significantly larger dimension than the other.

The semifinished transponder product itself is advantageously formed such that, when rolling up, through specific positioning of the sub-regions lying on top of one another, the resonance frequency of the thus-forming transponder can be tuned. Here, the circuit paths are preferably formed such that the size of the overlapping portion can be selected through the positioning.

According to a further embodiment of the present invention, the semifinished transponder product is advantageously formed such that, when rolling up, independently of the chosen circumference, within a permitted range, the resonance frequency of the transponder does not change significantly. Here, the circuit paths are preferably formed such that the size of the overlapping portion decreases with increasing circumference in such a way that the attendant increasing inductance of the antenna is compensated for by a decreasing capacity.

The present invention further includes a method for manufacturing a transponder according to the first aspect of the present invention, in which an electronic memory chip is coupled with a magnetic ring antenna, the ring antenna being developed having an electrically conductive coil having at least one turn and having a capacitor, and the transponder being designed for an operating frequency of 860 MHz or more for UHF or the microwave range.

The present invention also includes a method for manufacturing a transponder according to the second aspect of the present invention, in which an electronic memory chip is coupled with a magnetic ring antenna, the ring antenna is developed having an electrically conductive coil having at least one turn and having a capacitor, and wherein the capacitor is developed having, as a dielectric, a thin insulator foil that simultaneously serves as a substrate foil for the coil and/or the chip.

The present invention is especially also directed to a method for manufacturing a transponder according to the above-described advantageous development of the second aspect of the present invention, which includes the method steps:
providing a transponder, having an electronic memory chip and a magnetic ring antenna, that is applied on a thin insulator foil,
providing a secondary antenna, preferably on a secondary-antenna substrate foil, and
joining the transponder and the secondary antenna, especially affixing them on top of one another, in such a way that the secondary antenna and the ring antenna are electrically coupled via the thin insulator foil and/or the secondary-antenna substrate foil.

Here, the secondary antenna is preferably provided as a dipole, patch or slot antenna. In a transponder that is intended for marking an object, the secondary antenna can also be provided as part of the object to be marked.

In all method aspects, the coil comprises, in an advantageous method, only one turn, and the transponder component, especially as a chip or chip module, is applied such that it is coupled directly without a bridge to both ends of the coil.

In all method variants, a transponder component can be applied, especially affixed and electrically joined with the coil by welding or bonding.

The transponder is preferably provided with a protective layer. Here, the protective layer is preferably formed by an applied lacquer or plastic layer or an appropriately comprehensive protective body.

The invention will be explained in greater detail below by reference to exemplary embodiments in association with the drawings. Only the elements that are essential to understanding the present invention are depicted. Shown are:

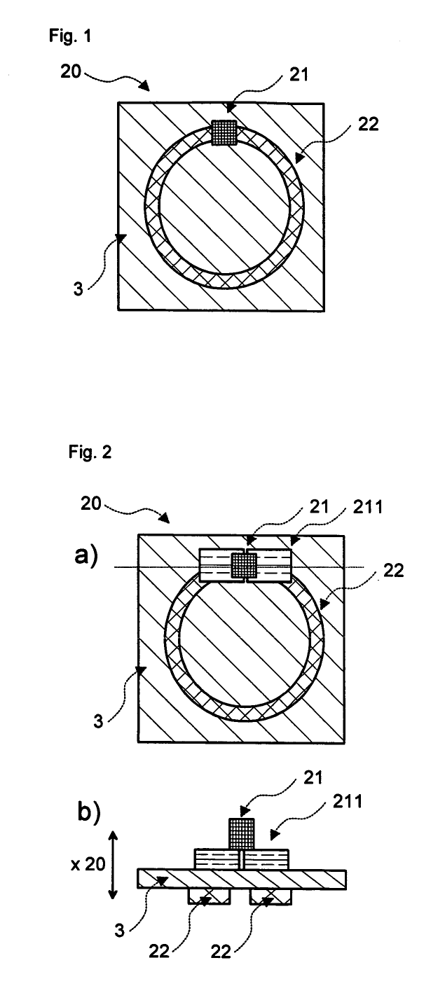

FIG. 1 in top view, a transponder having a magnetic ring antenna that comprises only one turn and is suitable for the UHF frequency range;

FIG. 2 an exemplary embodiment of a transponder according to the present invention, in which the substrate foil simultaneously serves as a dielectric for the capacitor of the ring antenna, wherein (a) shows a top view and (b) a cross section, stretched 20-fold, along the line B-B of (a);

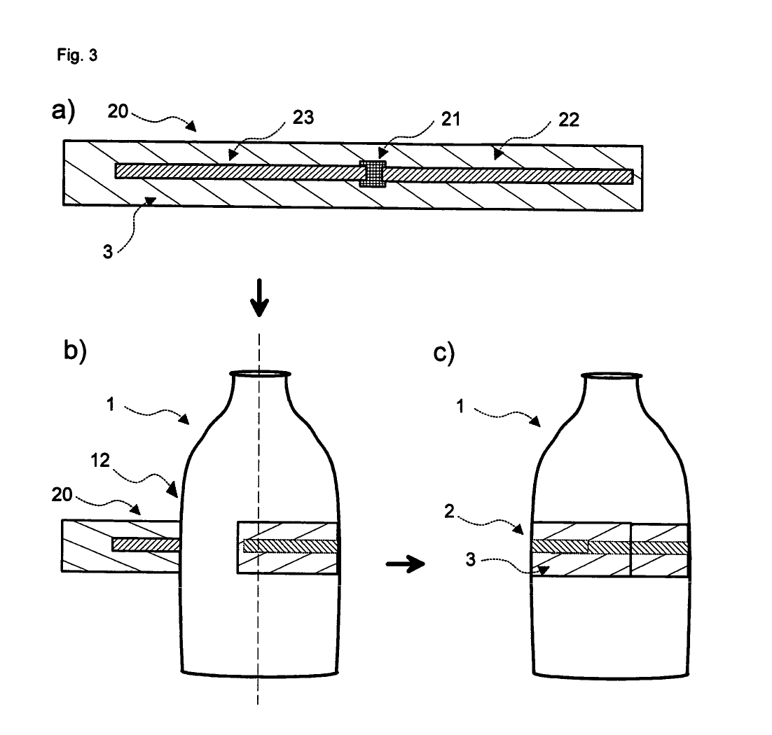

FIG. 3 the marking of a cylinder-shaped object with the aid of a self-adhesive semifinished transponder product: a) self-adhesive semifinished transponder product having an open coil, b) affixing the semifinished transponder product to the object, c) finished object marked by means of a transponder;

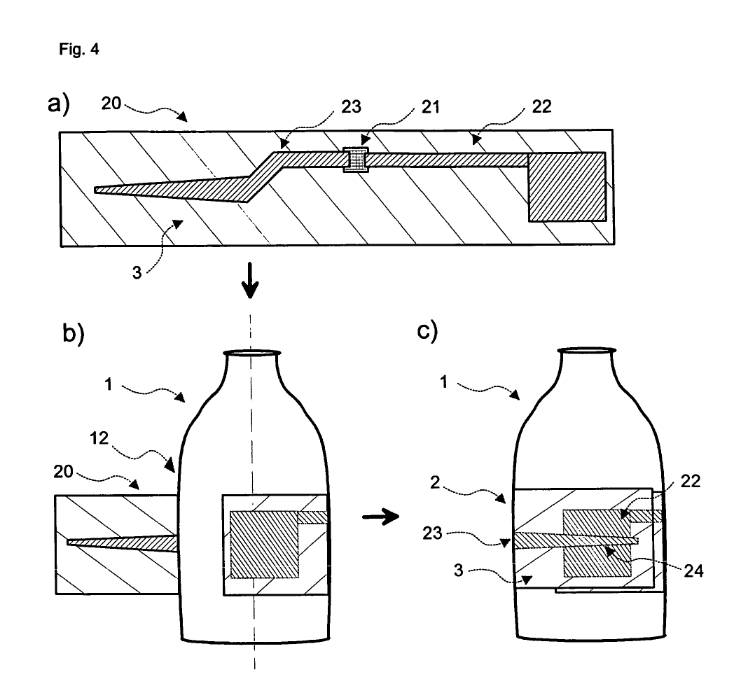

FIG. 4 the marking of a cylinder-shaped object with the aid of a self-adhesive semifinished transponder product that is formed such that the resonance frequency does not change, neither due to positioning imprecisions nor due to variations in the circumference of the object;

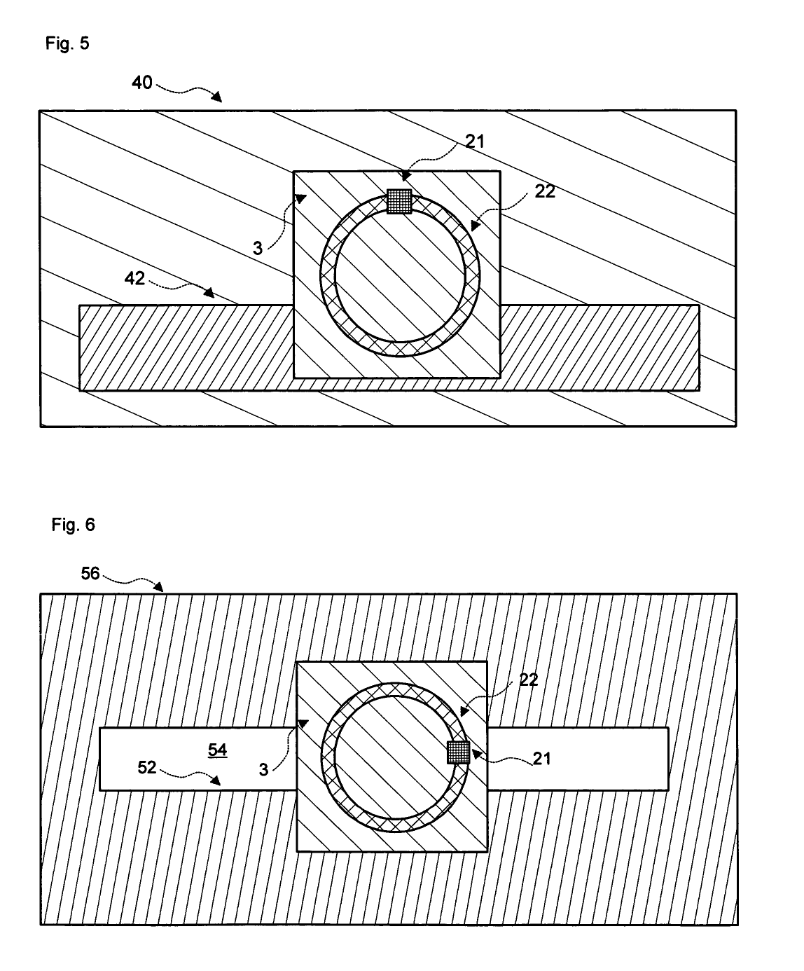

FIG. 5 a transponder having a transponder chip, a ring antenna and a secondary antenna formed by a dipole antenna; and

FIG. 6 a transponder having a transponder chip, a ring antenna and a secondary antenna formed by a slot antenna.

### MANNER OF EXECUTING THE INVENTION

First, with reference to FIG. 1, a transponder having a magnetic ring antenna that comprises only one turn is explained.

In FIG. 1, reference number 21 refers to the transponder chip, 22 the antenna coil and 3 a substrate composed of plastic. Here, the chip is applied directly to the coil via a flip-chip method. The antenna coil has a diameter of merely 1 cm, with its inductance being about 0.1 pH. Together with a capacitor integrated in the transponder chip, a ring antenna is created that is tuned to 868 MHz.

As in the exemplary embodiment in FIG. 1, the coil 22 and chip 21 can be applied on the same side of the plastic substrate 3 or, as in the following exemplary embodiments, they can be arranged on opposing sides of the substrate 3.

FIG. 2 shows an embodiment of the transponder according to the present invention, in which the substrate foil 3 of the antenna coil 22 simultaneously functions as a dielectric for the capacitor of the ring antenna. FIG. 2a shows the transponder in top view, while FIG. 2b represents a cross section, stretched by a factor of 20, along the dotted line B-B shown in FIG. 2a.

In FIG. 2a, the chip is applied indirectly as a chip module 211. The advantage here is that the standards for precision when applying the chip module are lower. On the one hand, the ring antenna is formed from the antenna coil 22 as an inductive element and, on the other hand, from two capacitors that, in turn, consist of the sections of the antenna coil 22 lying on top of one another, and of the chip module 211 as an electrode and the foil 3 as a dielectric.

One advantage of this embodiment, in addition to the compact design, lies in the simple mounting of the chip module, which need not be executed electrically conductively. Moreover, the transponder can be tuned through the thickness of the foil, and especially also through the positioning of the chip module—also after both the chip module 211 and the antenna coil 22 are already finished.

FIG. 3 shows the marking of a bottle with the aid of a self-adhesive semifinished transponder product. The self-adhesive semifinished transponder product 20 (FIG. 3a) is assembled on a self-adhesive foil 3 and comprises the transponder chip 21, as well as circuit paths 22 and 23 for assembling the transponder coil, the transponder chip 21 being contacted with the two circuit paths by means of the flip-chip method. The circuit paths 22, 23 are arranged such that their open ends come to lie on top of one another when the semifinished transponder product is affixed to a cylinder-shaped object having a specified circumference.

In FIG. 3b is depicted how the semifinished transponder product 20 is affixed to the cylinder-shaped section 12 of a bottle 1. In a completely affixed semifinished transponder product (FIG. 3c), the circuit paths 22, 23 form, together with the foil 3, a ring antenna that, together with the contacted chip, results in a functional transponder 2. Here, the foil 3 forms, on the one hand, the dielectric for a capacitor that is formed in the overlapping region of the circuit paths 22 and 23, and on the other hand, a through protective layer for the transponder. Here, it can simultaneously serve as a printable label for the bottle.

FIG. 4 shows the marking of a bottle with the aid of a self-adhesive semifinished transponder product whose application is insensitive to positioning imprecisions and variations in the circumference of the bottle. The circuit paths 22 and 23, in turn, are arranged such that their open ends come to lie on top of one another when the semifinished transponder product is affixed to a cylinder-shaped object having a specified circumference.

Furthermore, the circuit paths 22 and 23 are formed such that, in the region of the sub-sections 24 of the two circuit paths lying on top of one another, the one circuit path 22 has a significantly larger dimension than the other circuit path 23. In this way, in the case of positioning imprecisions, i.e. in the case of slight shifts of the circuit paths 22 and 23 relative to one another, the surface area of the overlapping sub-section 24, and thus the capacity of the capacitor formed therefrom, remains nearly constant.

Further, the width of the circuit path 23 decreases toward the outside. Upon application of the semifinished product to bottles of different diameters, the size of the overlapping portion 24 of the circuit paths decreases the larger the diameter is—within a permitted range. Thus, also the capacity of the capacitor formed therefrom decreases accordingly and compensates for the increasing inductance of the antenna ring formed from the circuit paths in such a way that the resonance frequency of the transponder remains practically constant within the permitted range.

In this way, overall, an insensitivity of the transponder assembly to positioning imprecisions when mounting and to variations in the circumference of the marked bottles is achieved.

FIG. 5 shows a transponder having a transponder chip 21, a ring antenna 22 on a substrate foil 3, and a dipole antenna 42 as a secondary antenna. Here, the dipole antenna 42 is applied on a further substrate foil 40 and electrically coupled to the ring antenna 22 via the substrate foil 3.

The exemplary embodiment in FIG. 6 shows a transponder having a transponder chip 21, a ring antenna 22 on a substrate foil 3, and a slot antenna 52 that consists of a slot 54 in a metallic object 56. The slot antenna 52 is electrically coupled to the ring antenna 22 via the substrate foil 3.

The exemplary embodiments in FIGS. 5 and 6 offer particularly high versatility by combining two components (a transponder having a ring antenna and a secondary antenna). They include, namely, on the one hand, a relatively complex but small and standardized component (a transponder having a ring antenna) and, to improve the reception characteristics of this transponder, combine this component with a secondary antenna optimized for the electromagnetic far field. In this way, the transponder can be flexibly adjusted to different materials or ambient conditions merely by adjusting the secondary antenna.

While the invention has been shown and described with particular reference to preferred exemplary embodiments, it will be understood by the person skilled in the art that changes can be made in the form and details without departing from the spirit and scope of the invention. Accordingly, the disclosure of the present invention is not intended to be limiting. Instead, the disclosure of the present invention is intended to illustrate the scope of the invention as set forth in the following claims.

1-49. (canceled)

50. A transponder having an electronic memory chip and a magnetic ring antenna, wherein
the ring antenna comprises an electrically conductive coil having only one turn, and a capacitor, and
the transponder is configured for an operating frequency of at least 860 MHz for UHF or the microwave range.

51. The transponder according to claim 50, further comprising
a secondary antenna electrically coupled to the ring antenna via an insulator foil, wherein
the secondary antenna forms a dipole, patch or slot antenna.

52. The transponder according to claim 51, wherein the secondary antenna is electrically coupled to the ring antenna via substrate foil of the ring antenna.

53. The transponder according to claim 51, wherein the secondary antenna is present on a secondary-antenna substrate foil, and is electrically coupled to the ring antenna via the secondary-antenna substrate foil.

54. The transponder according to claim 51, wherein the insulator foil is a plastic foil, a polyester (PET) foil, a polyimide foil or a polypropylene (PP) foil.

55. The transponder according to claim 51, wherein the secondary antenna is formed by a gap in an otherwise contiguous metal layer.

56. The transponder according to claim 55, wherein the secondary antenna is formed by etching the gap out of a contiguous metal foil.

57. The transponder according to claim 55, wherein the secondary antenna is formed by printing a conductive paste.

58. The transponder according to claim 50, wherein the secondary antenna is part of an object to be marked.

59. The transponder according to claim 50, wherein the inductance of the coil is less than 1 μH and the circumference of the coil is less than 20 cm.

60. The transponder according to claim 50, wherein the capacity of the capacitor is selected from the range 0.1 pF to 20 pF, preferably from the range 0.5 pF to 5 pF.

61. The transponder according to claim 50, wherein the coil area A is less than 40 cm².

62. The transponder according claim 50, further comprising an adhesive layer for use with the transponder as a self-adhesive transponder label.

63. The transponder according to claim 50, wherein the coil is formed by a circuit path on a substrate foil.

64. The transponder according to claim 63, wherein the circuit path is formed by etching out of a contiguous metal foil or by printing a conductive paste.

65. A method for manufacturing a transponder, comprising:
providing and coupling an electronic memory chip with a magnetic ring antenna, which comprises an electrically conductive coil having only one turn, and a capacitor,
wherein the transponder is configured for an operating frequency of at least 860 MHz for UHF or the microwave range.

66. The method of claim 65, further comprising:
providing a secondary antenna that forms a dipole, patch or slot antenna, and
joining the transponder and the secondary antenna in such a way that the secondary antenna and the ring antenna are electrically coupled via an insulator foil.

67. The method according to claim 65, further comprising applying a transponder component electrically joined with the coil by welding or bonding.

68. The method according to claim 67, wherein the transponder component is applied such that it is coupled directly without a bridge to both ends of the coil.

69. The method according to claim 65, further comprising providing the transponder with a protective layer.

70. The method according to claim 69, further comprising forming the protective layer by an applied lacquer or plastic layer, or an appropriately comprehensive protective body.

71. A transponder having an electronic memory chip and a magnetic ring antenna, wherein
the ring antenna comprises an electrically conductive coil having at least one turn, and a capacitor, and wherein
the capacitor exhibits, as a dielectric, a thin insulator foil that simultaneously serves as a substrate foil for the coil and/or the chip, and
the transponder further comprises a secondary antenna that is electrically coupled to the ring antenna via an insulator foil, wherein
the secondary antenna forms a dipole, patch or slot antenna.

72. The transponder according to claim 71, wherein the insulator foil is a plastic foil, a polyester (PET) foil, a polyimide foil or a polypropylene (PP) foil.

73. The transponder according to claim 71, wherein the entire transponder is assembled on the insulator foil.

74. The transponder according to claim 71, wherein the coil and the memory chip are assembled on opposing surfaces of the insulator foil.

75. The transponder according to claim 71, further comprising a second insulator foil joined with the first insulator foil in such a way that the coil is wrapped between the two insulator foils.

76. The transponder according to claim 71, wherein the secondary antenna is electrically coupled to the ring antenna via the substrate foil of the ring antenna.

77. The transponder according to claim 71, wherein the secondary antenna is present on a secondary-antenna substrate foil, and is electrically coupled to the ring antenna via this secondary-antenna substrate foil.

78. The transponder according to claim 71, wherein the secondary antenna is present on a secondary-antenna substrate foil in the form of a plastic foil, a polyester (PET) foil, a polyimide foil or a polypropylene (PP) foil.

79. The transponder according to claim 71, wherein the secondary antenna is formed by a gap in an otherwise contiguous metal layer.

80. The transponder according to claim 79, the secondary antenna is formed by etching the gap out of a contiguous metal foil.

81. The transponder according to claim 79, wherein the secondary antenna is formed by printing a conductive paste.

82. The transponder according to claim 71, wherein the secondary antenna is part of an object to be marked.

83. The transponder according to claim 71, wherein the transponder is configured for an operating frequency above 10 MHz.

84. The transponder according to claim 71, wherein the thickness of the insulator foil serving as a dielectric is below about 50 μm.

85. The transponder according to claim 71, wherein the transponder is functional in the case of a planar insulator foil serving as a dielectric, and the antenna coil is arranged parallel to the insulator foil.

86. The transponder according to claim 71, wherein the insulator foil serving as a dielectric does not lie parallel to the area spanned by the antenna, but rather protrudes out from it.

87. The transponder according to claim 86, wherein the insulator foil serving as a dielectric is rolled up to form a closed tube along whose circumference the coil runs.

88. The transponder according to claim 86, wherein the circuit paths are formed such that the resonance frequency of the antenna does not shift due to positioning imprecisions when rolling up.

89. The transponder according to claim 86, wherein the circuit paths are formed such that, when rolling up, the resonance frequency of the transponder can be tuned through specific positioning of the sub-regions lying on top of one another.

90. The transponder according to claim 71, wherein the coil area A is less than 40 cm².

91. The transponder according to claim 71, wherein an adhesive layer is provided for the use of the transponder as a self-adhesive transponder label.

92. The transponder according to claim 71, wherein the coil is formed by a circuit path on a substrate foil.

93. The transponder according to claim 92, wherein the circuit path is formed by etching out of a contiguous metal foil or by printing a conductive paste.

94. The transponder according to claim 71, in which the number of turns of the coil is less than 20.

95. A method for manufacturing a transponder, comprising:
providing a transponder, having an electronic memory chip and a magnetic ring antenna, that is applied on a thin insulator foil,
providing a secondary antenna that forms a dipole, patch or slot antenna, preferably on a secondary-antenna substrate foil, and
joining the transponder and the secondary antenna in such a way that the secondary antenna and the ring antenna are electrically coupled via the thin insulator foil and/or the secondary-antenna substrate foil.

96. The method according to claim 95, further comprising providing the secondary antenna as part of an object to be marked.

97. The method according to claim 95, further comprising coupling an electronic memory chip with a magnetic ring antenna, wherein the ring antenna is developed having an electrically conductive coil having at least one turn and having a capacitor, and wherein the transponder is designed for an operating frequency of at least 860 MHz for UHF or the microwave range.

98. The method according to claim 95, further comprising applying a transponder component electrically joined with the coil by welding or bonding.

99. The method according to claim 98, wherein the coil comprises only one turn, and the transponder component is applied such that it is coupled directly without a bridge to both ends of the coil.

100. The method according to claim 95, further comprising providing the transponder with a protective layer.

101. The method according to claim 100, further comprising forming the protective layer by an applied lacquer or plastic layer, or an appropriately comprehensive protective body.
